(19) United States
(12) Patent Application Publication
(10) Pub. No.: US 2022/0121174 A1
(43) Pub. Date: Apr. 21, 2022

(54) METHOD OF CONTROLLING A LIVESTOCK FARM

(71) Applicant: EVONIK OPERATIONS GMBH, Essen (DE)

(72) Inventors: Achim MARX, Gelnhausen (DE); Johann FICKLER, Mömlingen (DE); Walter PFEFFERLE, Langgöns (DE); Stefan PELZER, Gütersloh (DE)

(73) Assignee: EVONIK OPERATIONS GMBH, Essen (DE)

(21) Appl. No.: 17/297,364

(22) PCT Filed: Nov. 27, 2019
(86) PCT No.: PCT/EP2019/082658

§ 371 Date: May 26, 2021

(30) Foreign Application Priority Data
Nov. 28, 2018 (EP) 18208858.3

(51) Int. Cl. G05B 19/416; A01K 29/00; G06N 5/02

(52) U.S. Cl. CPC G05B 19/416; G05B 2219/31376; G06N 5/02; A01K 29/00

(57) ABSTRACT

A computer-implemented method of controlling a livestock farm housing a population of animals, the method comprising the steps of obtaining, by means of one or more, preferably a plurality of, sensors, farm sensor data indicative of the condition of the livestock farm; optionally combining said farm sensor data with further data, indicative of the condition of the livestock farm, but not obtained via sensors, to obtain farm condition data; obtaining, by means of one or more, preferably a plurality, of measurement devices, animal status data of the livestock farm population; and selecting and continuously adjusting, dependent on the obtained farm sensor data or farm condition data and the animal status data, a set of animal supply values using a feedback loop such that a value of at least a selected one of the animal status data is optimized.

### BACKGROUND OF THE INVENTION

The present invention relates to a computer-implemented method and a system of controlling a livestock farm housing a population of animals as e.g. chicken or other poultry.

Farmers have typically managed and operated farmhouses, such as chicken houses by performing the day to day farm tasks manually. These tasks primarily included providing adequate feed and water to the housed animals or livestock. Overtime, it has been found that controlling certain parameters could lead to higher yields and quality in the livestock. For example, temperature, humidity, ventilation, feed cycles and lighting all contribute to successful livestock and improved yields. Moreover, through the selective breading process, certain desired characteristics like meat yield have been modified.

Control systems for farmhouses initially started with simple analog controls, such as thermostats to control temperature in the farmhouse. Digital controllers soon followed and have generally replaced manual or analog controls in farmhouses. The relevant parameters are generally controlled automatically, via various sensors and actuators positioned throughout the farmhouse. The parameters controlled in a farmhouse, such as a poultry or hog house, generally include temperature, humidity, water, ventilation, timers for feeder and waterers, and timers for illumination.

From US 2005/0010333 a system for monitoring, managing, and/or operating a plurality of farmhouses on a plurality of farms is known including a controller and/or a monitor box in the farmhouse and a computer in communication with the controller for controlling and adjusting various parameters of the farmhouse or with the monitor box for monitoring the farmhouse. The system also includes a computer at an integrator's office that is operable to monitor and/or control various parameters from the farmhouse remotely. These parameters enable the integrator to coordinate operations with processing plants, feed mills, field service and hatcheries. It also enables the integrator to prepare various data reports for use by the integrator or others. The integrator may standardize or determine optimal control parameters of various farms to achieve the best results as measured by the result parameters. The integrator may compare a feed rate of a first farmhouse and a second farmhouse and then compare the rate which the livestock reach a selected livestock weight. If one farmhouse achieves the selected result parameter faster, the integrator is able to determine a better control parameter to achieve the selected result parameter.

On a livestock farm today a lot of (sensor) data can thus be collected, such as temperature, air pressure, air flow, noises, CO₂, ammonia, water and feed intake, humidity, composition of the air. This large number of measurement data is very difficult for a farmer to consider in its entirety. The adjustment of animal supply values as reactions to farm sensor data changes can therefore not be carried out in the way that would theoretically be possible due to the complexity of the data. In addition, a certain change of (sensor) data does not only suggest a certain adjustment of particular animal supply values but rather several different adjustments are possible.

It is therefore an object of the present invention to provide a computer-implemented method and a system of controlling a livestock farm housing a population of animals as e.g. chicken or other poultry, which assists the farmer in improved use of the data collected at the farm in order to optimize the results obtained at the farm.

### SUMMARY OF THE INVENTION

This object is achieved by a computer-implemented method of controlling a livestock farm housing a population of animals, the method comprising the steps of obtaining, by means of one or more, preferably a plurality of, sensors, farm sensor data indicative of the condition of the livestock farm; optionally combining said farm sensor data with further data, indicative of the condition of the livestock farm, but not obtained via sensors, to obtain farm condition data; obtaining, by means of one or more, preferably a plurality, of measurement devices, animal status data of the livestock farm population; and selecting and continuously adjusting, dependent on the obtained farm sensor data or farm condition data and the animal status data, a set of animal supply values using a feedback loop such that a value of at least a selected one of the animal status data is optimized.

The present invention furthermore provides a system for controlling a livestock farm housing a population of animals, the system comprising one or more, preferably a plurality of, sensors adapted to obtain farm sensor data indicative of the condition of the livestock farm; optionally a device adapted to combine said farm sensor data with further data, indicative of the condition of the livestock farm, but not obtained via sensors, to obtain farm condition data; one or more, preferably a plurality of, measurement devices adapted to obtain animal status data of the livestock farm population; and a control unit adapted to select and continuously adjust, dependent on the obtained farm sensor data or farm condition data and the animal status data, a set of animal supply values using a feedback loop such that a value of at least a selected one of the animal status data is optimized.

Sensor data may be obtained and monitored randomly, continuously and/or at pre-defined time intervals. The same applies for obtaining the animal status data.

The farmer or farm operator can choose a particular animal status data or a combination of a plurality of values as performance indicator(s) and continuously optimize these values based on the feedback mechanism and using the animal supply values as variable system input values. Animal supply values may include at least animal feed supply values and animal water supply values.

For optimization of the animal supply values using the feedback loop artificial intelligence (AI) may be used. Suitable AI approaches to be applied to the feedback loop are machine learning and machine reasoning, or the combination of both.

In the machine reasoning approach, the adjusting step is performed using a network of selectively connected, predefined knowledge building blocks, wherein each knowledge building block maps an input state to an output value according to a predefined knowledge rule; the output value of a knowledge building block may be the input state of another knowledge building block; the set of knowledge building blocks defines the animal supply values dependent on the obtained farm sensor data or farm condition data, and the connections of the network of knowledge building blocks are adapted based on the measured animal status data of the livestock farm population.

This network of knowledge building blocks allows to feed previously obtained knowledge at a fine granular level into the feedback mechanism and thus serves as an AI-driven mechanism to adjust the selected set of animal supply values.

The knowledge building blocks preferably define previously obtained rules representing the reaction of the animals to particular farm conditions.

As an alternative to using the network of knowledge building blocks, the adjusting step may be performed using a machine learning approach. In contrast to the rule-based machine reasoning approach described above, machine learning uses mathematical and statistical models to learn from data sets. There are dozens of different machine learning procedures. In principle, machine learning distinguishes between two systems: First, symbolic approaches such as pronunciation-logical systems, in which knowledge is explicitly represented. Second, sub-symbolic systems such as artificial neural networks, which function along the lines of the human brain and in which knowledge is implicitly represented.

According to the present invention, a machine learning procedure may be operating on an artificial neural network to iteratively optimize the set of animal supply values dependent on the obtained farm sensor data, wherein the animal status data are used as target data for training the neural network.

The term “sensor” refers to any device, module, machine or subsystem whose purpose is to detect data, changes or events in its environment and sends the information to other electronics, preferably a computer processor. Accordingly, farm senor data are farm data collected via sensors that are located within the livestock farm.

The sensors used in the method according to the present invention may include optical, acoustical and/or chemical sensors.

Preferably, an optical or acoustical alarm signal is generated if one of the obtained farm sensor data is outside of a predefined range.

The farm sensor data may optionally be combined with further data indicative of the condition of the livestock farm, but not obtained via sensors. Thereby, farm condition data are obtained.

Farm sensor data and/or farm condition data may comprise data about animal age, dimension of the farm, lighting and ventilation conditions, or the vaccination schedule, data on feed and water consumption (animal metabolic data), weight, or behavior of the animals. The farm sensor data and/or farm condition data may further include one or more of temperature, air pressure, data on distribution and movement of the animals within the farmhouse, motoric activity of the animals, sound data, air composition data and olfactory data.

The term “animal status data” refers to data about the state, condition or situation of the livestock farm population. Accordingly, the animal status data are directly correlated to the animal population and may include one or more of animal health and mortality, caloric conversion and feed conversion rates, body weight gain of the animals, slaughter yield, quantity, quality and variability of a produced meat.

The animal supply values which serve as the input data of the farmhouse may include one or more of a quantity, quality and composition of the animal feed, diet, supplements, probiotics, drugs, water supply, temperature, air pressure, ventilation, lightning, sound and humidity in the farmhouse.

### BRIEF DESCRIPTION OF THE DRAWINGS

The present invention will become more readily apparent from the following description of detailed embodiments thereof in connection with the enclosed drawings, in which:

FIG. 1 is a schematic illustration of the general correlations between animal supply values, farm sensor data and animal status data;

FIG. 2 is a schematic illustration of an exemplary feedback loop according to an embodiment of the present invention;

FIG. 3 is a schematic illustration of a multi-stage feedback loop according to an embodiment of the present invention;

FIG. 4 is a schematic illustration of a network of knowledge building blocks according to an embodiment of the present invention;

FIG. 5 is a schematic illustration of an exemplary feedback loop based on a network of knowledge building blocks according to an embodiment of the present invention;

FIG. 6 is a schematic illustration of an adjustment process using exemplary knowledge building blocks according to an embodiment of the present invention;

FIG. 7 is a schematic illustration of an adjustment process using exemplary knowledge building blocks according to a further embodiment of the present invention.

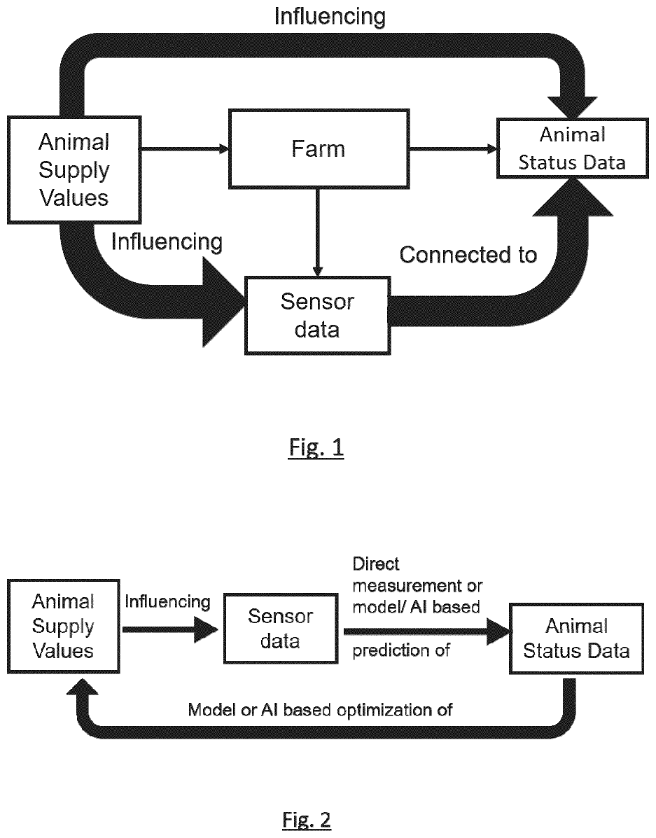

### DETAILED DESCRIPTION OF PREFERRED EMBODIMENTS

The present invention relates to a computer-implemented method and a system of controlling a livestock farm housing a population of animals as e.g. chicken or other poultry. The invention is not restricted to a particular type of farmhouse, but is applicable to all types thereof having the facilities to house and feed the animal population. An exemplary farmhouse may be a poultry house.

The farmhouse (not shown in the drawings) comprises a plurality of sensors including optical, acoustical and/or chemical sensors obtaining farm sensor data. These can include data on temperature, air pressure, ventilation, lightning, on distribution and movement of the animals within the farmhouse, motoric activity of the animals, weight of the animals, feed and water consumption, sound data, air composition data and olfactory data.

Distribution, movement, and motoric activity of the animals may be determined by statistical analysis of video- or photo-based data. Animal weight may be determined using an appropriate weight meter, such as one that measures the force produced on a roosting rod of chicken roost.

Feed consumption may be determined using a feeder with a fill system including a flow meter that is able to measure the amount of feed provided to the farm house that is consumed by the livestock contained therein. Air composition and olfactory data may, for example, be determined using electronic noses or gas chromatography (GC).

In addition, the farmhouse comprises facilities to provide the animal population with defined quantities of the necessary supplies of, for example, water, feed, ventilation, temperature, humidity, feed supplements, probiotics, drugs, vaccination etc. The quantities of the aforementioned parameters (the animal supply values) serve as the variable input parameters influencing the well-being and success of the animal population.

The ventilation system (typically including fans that can be turned off and on and fan shutters that may open and close) allow for controlling the amount of fresh air intake into the farm house and also for pressure differentiation. The ventilation system, including its various components, may affect temperature and air quality (such as ammonia and carbon dioxide concentration and oxygen levels) within the farm house.

Temperature may be indirectly controlled via the ventilation system. However, it may also be directly controlled by an evaporative cooling system and brooders. The evaporative cooling system can not only adjust the temperature parameter but also the humidity level within the farm house by drawing air through a wetted pad.

Feeding and watering of the animals, preferably swine and chicken, may be controlled by (automated) feeders that are supplied by a feed bin and a fill system.

Animal status data including data on animal health and mortality, such as live weight, caloric conversion and feed conversion rates, body weight gain of the animals, slaughter yield, quantity, quality and variability of a produced meat are directly or indirectly obtained continuously or at predetermined intervals.

The animal status data serve as the performance indicators of the optimization process according to the present invention. The farmer or farm operator can chose the desired status parameter or multiple parameters to optimize the meat production for his/her purposes.

Various animal supply values such as feed and water quality and quantity, addition of feed additives, temperature, air flow, noise, weather conditions, humidity, air composition have an influence on the performance and certain status data of the animals. The key animal status data can be directly measured or indirectly predicted. For the prediction artificial intelligence can be used.

In order to optimize the animal status data the animal supply values are continuously adjusted. The feedback loop driven by the animal supply values and influencing the farm sensor data and the animal status data is schematically illustrated in FIG. 2. A production run begins with a pre-defined set of animal supply values (presets). During the process, farm senor data are obtained via sensors. Animal status data may be obtained via direct measurement. Depending on the farm sensor data and the animal status data obtained, the animal supply values are continuously adjusted by the feedback loop. Thereby, the farm as a whole can be controlled and the production results (intermediate and final) can be optimized.

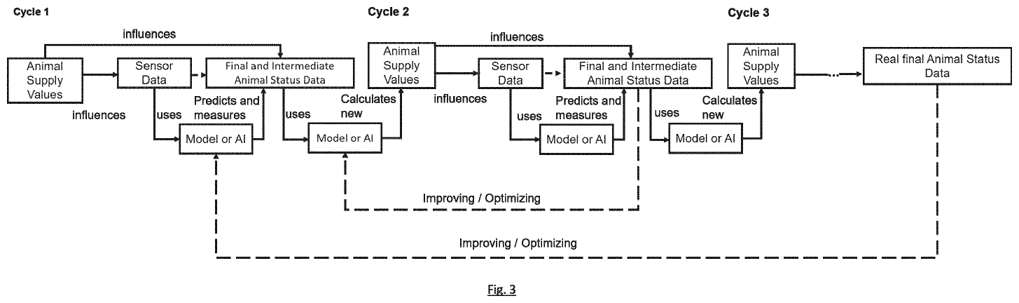

Based on the fundamental feedback loop depicted in FIG. 2, the use of artificial intelligence can take over and optimize the decision about the adjustment of the change of the animal supply values within the totality of the available data. A three-stage cycle to optimize the animal status data is schematically shown in FIG. 3. A first AI-driven feedback cycle optimizes a first set of final and intermediate animal status data, followed by a second cycle of improvement and a third improvement cycle outputting the real final animal status data. Accordingly, the status data, and thus the actual status of the animal population is iteratively optimized by continuously adjusting the animal supply values.

For applying artificial intelligence to the feedback loop, two different approaches may be applied, namely machine reasoning and machine learning.

### 1. Use of Machine Reasoning

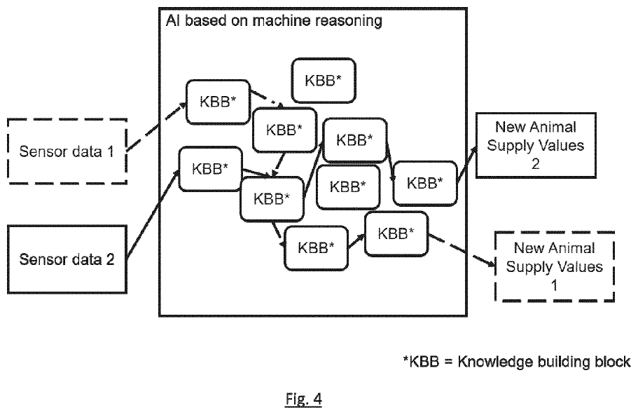

The AI-component in machine reasoning systems are networks formed of state-dependent knowledge modules called knowledge building blocks (KBB) as illustrated in FIG. 4. Such knowledge building blocks contain finely granular rules, which are joined together by the AI to form a flexible rule network. These rules can include e.g. optimum values of feed and water consumption or weight profiles, feed conversion, background noise (stress indicator), etc., which are coupled via models with the actions to be applied in certain conditions. As an action either the branching to another knowledge building block could be carried out or also a certain change of input parameters, like e.g. the feed composition, the addition of certain feed additives, medicines, the change of temperature, ventilation, etc. For the purpose of simple illustration, the KBBs in FIG. 4 also include animal status data.

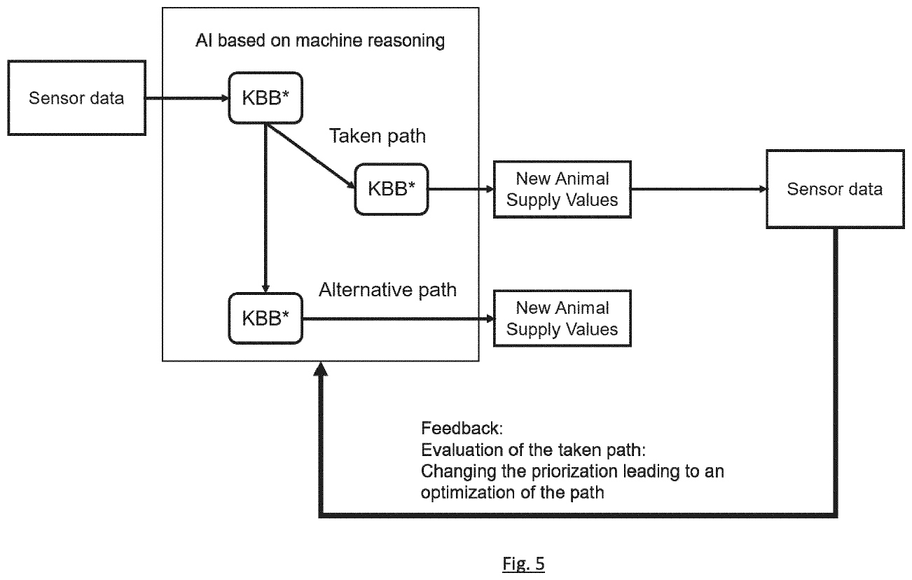

If the animal supply values are adjusted by the AI, this results in a change in the farm sensor data (and the animal status data) as depicted in FIG. 5. The resulting new animal status data (performance indicator) is used to evaluate the quality of the network of knowledge building blocks, so that the network is continuously optimized and different networks are evaluated and weighted by the knowledge building blocks. With this feedback, the AI learns which reactions to certain changes in the animal status data are advantageous. This feedback can also occur indirectly if the decision to change the animal supply values is previously approved/evaluated by humans.

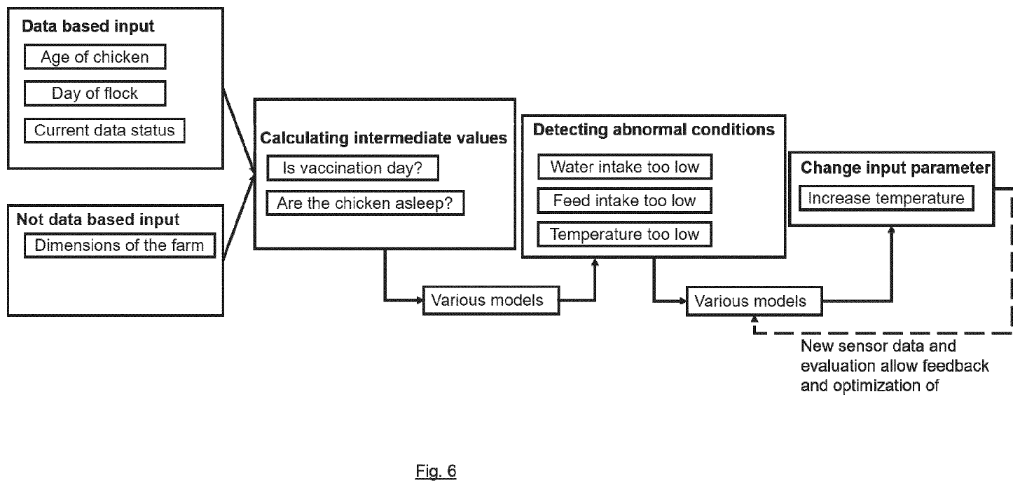

An example for the use of Machine Reasoning is the digitization of a decision tree that has been carried out by humans so far, which evaluates the farm status and gives advice in order to maintain or restore an optimal condition. A human decision tree may be based on a variety of data and decisions. In a first step of digitization one may concentrate on feed and water data, as e.g. illustrated by the two ‘branches’ of the decision tree shown in FIG. 6.

It may be advantageous, however, to integrate more branches of the decision tree. In addition, the advice could be integrated and the results of the advice fed back in order to optimize the way through the network of knowledge building blocks. A short concrete example thereof is the following: All chickens of a farmhouse crouch together in the middle of the stable. This is automatically detected by video sensors and registered as an abnormal condition. The AI of the method according to the present invention can derive several reasons why this could be so: 1) the ventilation is too strong, or 2) there is no bedding material on the floor close to the walls. These reasons are statistically weighted, so that the AI of the invention knows that in most cases—and together with all other data—the ventilation is too strong and therefore acts to reduce the ventilation. If this does not have the desired effect, the method can take the alternative route and provide a signal to the stable staff informing it that more bedding material should be equally distributed on the floor. With the feedback from the new video images, the AI-based method can learn which way through the network was the better one and decide which route to take the next time a similar situation occurs.

Optimization of KBBs can also take place via machine learning. This approach is named “reinforcement learning”. Multiple runs may be necessary in order to obtain optimized KBBs.

In an exemplary case, water and feed consumption at a broiler farm are used to evaluate the condition of the chickens. Water and feed serve as indications of whether the chickens are exposed to stress and thus achieve lower feed utilization, are exposed to diseases, or have an effect on disturbing factors which influence the growth of the chickens.

Various rules can be formulated as knowledge building blocks and integrated into the AI-based system. Examples of such rules are: (a) Today's water consumption must be higher than yesterday's water consumption at the same time of day; (b) If vaccination is in progress, water consumption is lower; (c) If the chickens are asleep, they do not consume any water.

The knowledge building blocks may be assigned to different categories, as exemplified in the following table:

| No. | Category | Example |
|---|---|---|
| 1. | Preparatory | Read in current feed data |
| | knowledge | Current time |
| | building blocks | |
| 2. | Fixed parameters | Plan of ‘night phases’ |
| | | Median feed intake per hour |
| 3. | Calculation of | Ratio of feed to water |
| | intermediate values | Verification of ‘night phase’ |
| 4. | Generation of alarms | Alarm that too much water was consumed |
| | | Alarm that too little water was consumed |
| 5. | Send and reset alarms | Send alarm to graphical user interface |
| | | Reset alarm |

Further KBB categories are “advice/recommendation” and “execution”.

The sensor data may be prepared in a first stage of the processing, these data are then compared with fixed parameters or calculated intermediate values. Then alarms are generated, which are subsequently displayed on e.g. a graphical user interface.

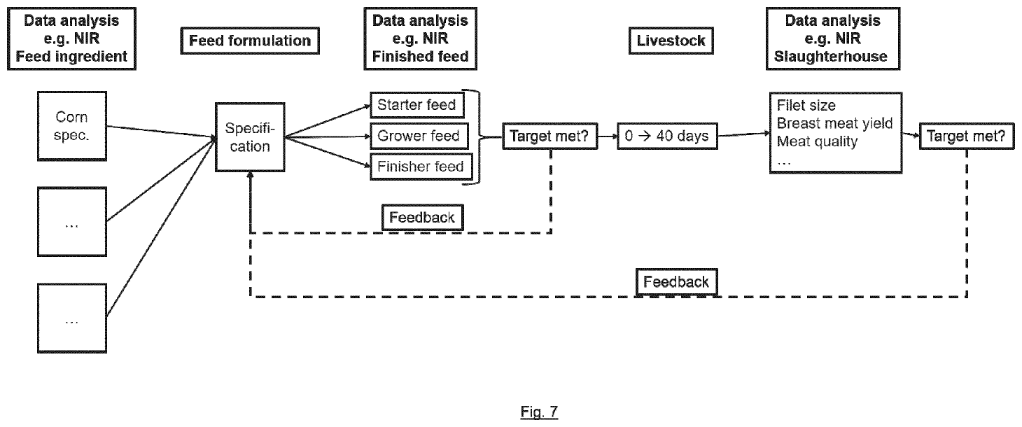

A further example of the application of machine reasoning is the coupling of raw material quality with flock quality. An example of subsequent stages of processing by the knowledge building blocks is shown in FIG. 7.

In many stables the direct connection between direct farm data and flock quality is drawn. It is well known that raw material quality and feed specification have a high influence on flock quality and performance. However, these two parameters have never been correlated online or used to optimize important chicken status or performance parameters.

For example, certain producers may want to increase the amount of breast meat per chicken as well as the size of the fillet in a given standard size for the whole flock. It is known that the amount of breast meat is essentially related essential nutrients, like the first limiting amino acid methionine. A NIR raw material analysis could thus provide precise data for optimum feed specification required for optimal breast. These models can then be optimized and extended through feedback and the use of additional parameters.

This AI-based method thus allows an integration from the raw materials to the slaughterhouse, which allows the animal production and in particular the chicken production to be optimized to a large extent according to certain animal status data as breast meat quantity or uniformity of the flocks, as schematically depicted in FIG. 7.

### 2. Use of Machine Learning

In the case of using machine learning for the optimization process according to the present invention, the input for the AI are the observed data. Based on this data, the AI fits the model, which describes the performance indicators mentioned above as the target variable and the input parameters mentioned above as the influencing factors. This trained model can then be applied to new data to obtain predictions/estimators of target values. Optimum input parameter settings can also be identified with regard to the target variable. Since the data-based model can only be validated on parameter combinations observed so far, however, an extrapolation beyond these may be challenging.

An example for the use of machine learning is the evaluation of pictures and videos taken in the stable. With machine learning it can be learned from pictures in the stable whether the distribution of the chickens is regular or whether the chickens huddle together. If this is the case, the chickens do not eat and drink regularly, which in turn affects the animal status parameters. One reason for this could be too much ventilation in the henhouses, causing the chickens to freeze.

1-15. (canceled)

16. A computer-implemented method of controlling a livestock farm housing a population of animals, the method comprising the steps of:
obtaining, by one or more sensors, farm sensor data indicative of the condition of the livestock farm;
optionally combining said farm sensor data with further data, indicative of the condition of the livestock farm, but not obtained via sensors, to obtain farm condition data;
obtaining, by one or more measurement devices, animal status data of the livestock farm population; and
selecting and continuously adjusting, dependent on the obtained farm sensor data or farm condition data and the animal status data, a set of animal supply values using a feedback loop such that a value of at least a selected one of the animal status data is optimized.

17. The method of claim 16, wherein the adjusting step is performed using a network of selectively connected, predefined knowledge building blocks, wherein:
each knowledge building block maps an input state to an output value according to a predefined knowledge rule;
the output value of a knowledge building block may be the input state of another knowledge building block;
the set of knowledge building blocks defines the animal supply values dependent on the obtained farm sensor data or farm condition data; and
the connections of the network of knowledge building blocks are adapted based on the measured animal status data of the livestock farm population.

18. The method of claim 17, wherein the knowledge building blocks define previously obtained rules representing a reaction of the animals to particular farm conditions.

19. The method of claim 18, wherein farm sensor data and/or farm condition data comprise data about animal age, dimension of the farm, lighting and ventilation conditions, or the vaccination schedule, data on feed and water consumption, weight, or behaviour of the animals.

20. The method of claim 16, wherein the adjusting step is performed using a machine learning procedure operating on a neural network to iteratively optimize the set of animal supply values dependent on the obtained farm sensor data or farm condition data, wherein the animal status data are used as target data for training the neural network.

21. The method of claim 16, wherein the sensors include optical, acoustical and/or chemical sensors.

22. The method of claim 16, wherein the farm sensor data and/or farm condition data include one or more of the following: temperature, air pressure, ventilation, lightning, data on distribution and movement of the animals within the farmhouse, motoric activity of the animals, weight of the animals, feed and water consumption, sound data, air composition data and olfactory data.

23. The method of one of claim 16, wherein the animal status data include one or more of the following: animal health and mortality, caloric conversion and feed conversion rates, body weight gain of the animals, slaughter yield, quantity, quality and variability of a produced meat.

24. The method of claim 16, wherein the animal supply values include one or more of the following: quantity, quality and composition of the animal feed, diet, supplements, probiotics, drugs, water supply, temperature, air pressure, ventilation, lightning, sound and humidity in the farm house.

25. The method of claim 16, wherein an optical or acoustical alarm signal is generated if one of the obtained farm sensor data is outside of a predefined range.

26. The method of claim 19, wherein the farm sensor data and/or farm condition data include one or more of the following: temperature, air pressure, ventilation, lightning, data on distribution and movement of the animals within the farmhouse, motoric activity of the animals, weight of the animals, feed and water consumption, sound data, air composition data and olfactory data.

27. The method of one of claim 26, wherein the animal status data include one or more of the following: animal health and mortality, caloric conversion and feed conversion rates, body weight gain of the animals, slaughter yield, quantity, quality and variability of a produced meat.

28. The method of claim 27, wherein the animal supply values include one or more of the following: quantity, quality and composition of the animal feed, diet, supplements, probiotics, drugs, water supply, temperature, air pressure, ventilation, lightning, sound and humidity in the farm house.

29. A system for controlling a livestock farm housing a population of animals, the system comprising:
one or more sensors adapted to obtain farm sensor data indicative of the condition of the livestock farm;
optionally a device adapted to combine said farm sensor data with further data, indicative of the condition of the livestock farm, but not obtained via sensors, to obtain farm condition data;
one or more, measurement devices adapted to obtain animal status data of the livestock farm population; and
a control unit adapted to select and continuously adjust, dependent on the obtained farm sensor data or farm condition data and the animal status data, a set of animal supply values using a feedback loop such that a value of at least a selected one of the animal status data is optimized.

30. The system of claim 29, wherein the control unit is adapted to select and continuously adjust the set of animal supply values using a network of selectively connected, predefined knowledge building blocks, wherein:
each knowledge building block maps an input state to an output value according to a predefined knowledge rule;
the output value of a knowledge building block may be the input state of another knowledge building block;
the set of knowledge building blocks defines the animal supply values dependent on the obtained farm sensor data or farm condition data; and
the connections of the network of knowledge building blocks are adapted based on the measured animal status data of the livestock farm population.

31. The system of claim 30, wherein the knowledge building blocks define previously obtained rules representing a reaction of the animals to particular farm conditions, and optionally wherein farm sensor data and/or farm condition data comprise data about animal age, dimension of the farm, lighting and ventilation conditions, or the vaccination schedule, and the animal metabolic data comprise data on feed and water consumption, weight, or behaviour of the animals.

32. The system of claim 31, wherein the control unit is adapted to use a machine learning procedure operating on a neural network to iteratively optimize the set of animal supply values dependent on the obtained farm sensor data or farm condition data, wherein the animal status data are used as target data for training the neural network.

33. The system of claim 29, comprising optical, acoustical, and/or chemical sensors to obtain real-time farm sensor data, and optionally comprising a device adapted to generate an optical or acoustical alarm signal if one of the obtained farm sensor data is outside of a predefined range.

34. The system of claim 29, wherein the control unit is adapted to select and continuously adjust the set of animal supply values using a network of selectively connected, predefined knowledge building blocks, wherein:
each knowledge building block maps an input state to an output value according to a predefined knowledge rule;
the output value of a knowledge building block may be the input state of another knowledge building block;
the set of knowledge building blocks defines the animal supply values dependent on the obtained farm sensor data or farm condition data; and
the connections of the network of knowledge building blocks are adapted based on the measured animal status data of the livestock farm population.

35. The system of claim 34, wherein the knowledge building blocks define previously obtained rules representing a reaction of the animals to particular farm conditions, and optionally wherein farm sensor data and/or farm condition data comprise data about animal age, dimension of the farm, lighting and ventilation conditions, or the vaccination schedule, and the animal metabolic data comprise data on feed and water consumption, weight, or behaviour of the animals.
